(19) United States
(12) Patent Application Publication
(10) Pub. No.: US 2017/0128321 A1
(43) Pub. Date: May 11, 2017

(54) HEADACHE TENSION MASSAGE HEADBAND

(71) Applicant: Derek Brian Crawford, McDonough, GA (US)

(72) Inventor: Derek Brian Crawford, McDonough, GA (US)

(21) Appl. No.: 14/934,137

(22) Filed: Nov. 5, 2015

(51) Int. Cl. A61H 23/02; A61H 23/00

(52) U.S. Cl. CPC A61H 23/0254; A61H 23/004; A61H 2205/02

(57) ABSTRACT

The head-massaging device comprises a headband for engaging over the head. Compartments in strategic positions of the headband carries an electro-mechanical wave's vibrator assembly, which is new to the art. An exterior power supply is provided. Each vibrator assembly create massage waves which engage the sides of the user's head. The waves creates vibration massaging that help to alleviate the problem of tension headache and mental stress, by massaging specific areas of the head applying direct vibration massaging to key positions on the head; the frontal lobe area, temporal lobe area and occipital lobe area.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The background of this invention involves massage therapy, the field of endeavor. Massage therapy is manual manipulation of soft body tissues (muscle, connective tissue, tendons and ligaments) to enhance a person's health and well-being. There are dozens of types of massage therapy methods (also called modalities) (University, 2015).

The use of head massagers is known in the prior art. More specifically, head massagers heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 5,421,799; U.S. Pat. No. 5,115,769; U.S. Pat. No. 5,569,166; U.S. Pat. No. 5,277,174; U.S. Pat. No. 3,478,736; U.S. Pat. No. Des. 368,141 and cited Pat. No. 6,179,794.

In these respects, the adjustable vibrating head massaging device according to the present invention substantially departs from the conventional concepts and designs of the prior art, and in so doing provides an apparatus primarily developed for the purpose of providing comfort and relief from headaches and the like (Ca., 2015). The former referenced inventions utilized physical-mechanical device apparatus to execute the massage process.

Information known to inventor: This present invention presents an economically new application of massaging the head by utilizing electromechanical vibration wave's device to execute the massage process. Tension headaches are becoming more common. Examples of causes are the increased use of computer screens (physical strain on the eyes causing tension headache) and personal situation worry (mental stress causing tension headache) in everyday life. This invention will help to alleviate the problem of tension headache and mental stress, by massaging specific areas of the head applying direct vibration massaging to key positions on the head; the frontal lobe area, temporal lobe area and occipital lobe area.

### BRIEF SUMMARY OF THE INVENTION

In summary the Headache Tension Massage Headband is an economical cloth device, containing vibrating mini motor discs (V.M.M.D.) size 0.5″ to 1.0″ diameter 0.125″ height circular pad), which is stretched and placed around the back and fore head. Once in place the vibrating mini motor discs (V.M.M.D.) are powered on using the coin cell battery holder switch. The vibrating intensity of the vibrating mini motor discs (V.M.M.D.) creates vibration massaging that help to alleviate the problem of tension headache and mental stress, by massaging specific areas of the head applying direct vibration massaging to key positions on the head; the frontal lobe area, temporal lobe area and occipital lobe area.

### BRIEF DESCRIPTION OF THE SEVERAL VIEWS OF THE DRAWING

FIG. 1 Top-View depicts a view looking down at the Headache Tension Massage Headband. The headband is a standard terrycloth variable sized sweat headband. The parts seen on the outside are top view of coin cell battery holder with off & on switch. Over top of it is seen a high and low intensity switch. Showing is six vibrating mini motor disc (V.M.M.D.) size 0.5″ to 1″ diameter 0.25″ height circular pad with wiring harness, all which are enclosed inside the headband.

FIG. 2 Right Side-View depicts a view looking at the right side of the Headache Tension Massage Headband. The headband is a standard terrycloth variable sized sweat headband. The parts seen on the outside are side view of the coin cell battery holder with off & on switch. Over top of it is seen a high and low intensity switch. Showing are four vibrating (V.M.M.D.) mini motor disc with wiring harness these parts are enclosed inside the headband.

FIG. 3 Left Side-View depicts a view looking at the left side of the Headache Tension Massage Headband. The headband is a standard terrycloth variable sized sweat headband. The parts seen are four vibrating mini motor disc (V.M.M.D.) with wiring harness all which are enclosed inside the headband.

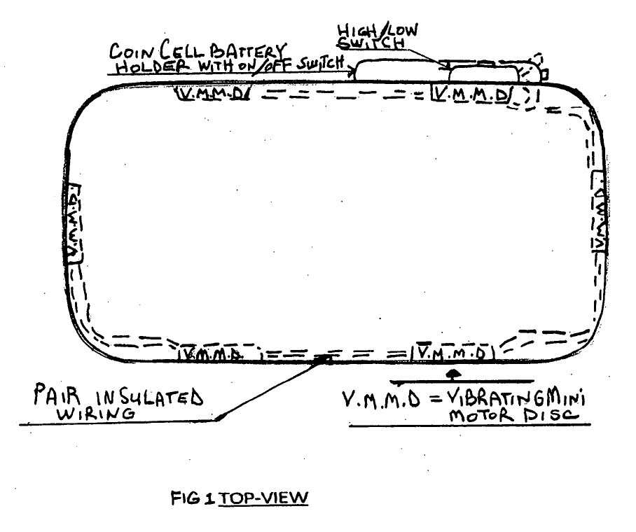

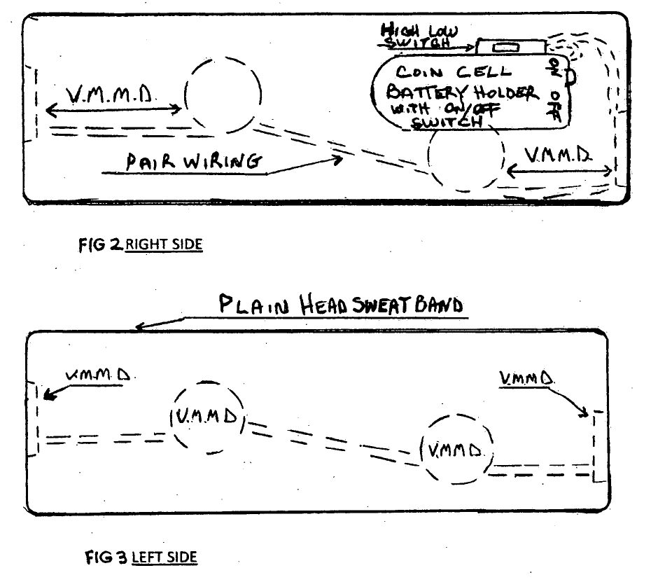

### DETAILED DESCRIPTION OF THE INVENTION

Headache Tension Massage Headband function involves working and massaging on the head with vibration, done with electro-mechanical aid. Massage will be applied with vibrating mini motor discs (V.M.M.D.) size 0.5″ to 1.0″ diameter 0.125″ height circular pad, stationary and strategically placed inside a sweat headband. This massage device can relieve tension promote relaxation and well-being.

Headache Tension Massage Headband has installed inside at strategic locations vibrating mini motor discs (V.M.M.D.). Base model have two vibrating mini motor discs (V.M.M.D.), advanced models have more than two. These motors are powered by paired wiring attached to a coin cell battery holder with off and on switch. Advanced models may have a speed/intensity controller.

The main part is a plain sweat headband made of stretchable terry cloth sized to fit snuggly around the circumference of the forehead section of the head. The headband has a hollow channel within itself, this channel will be used to contain and hold the wired harness of vibrating mini motor disc (V.M.M.D.).

Depending on the model the harness quantity of vibrating mini motor disc (V.M.M.D.) are between two and six. The base model have two vibrating mini motor disc and then model types increase by an additional two vibrating mini motor disc (V.M.M.D.) up to six total. The harness is made by wiring and attaching in parallel the vibrating mini motor disc (V.M.M.D.). The vibrating mini motor disc (V.M.M.D.) positive lead and negative lead are attached to premeasured corresponding conductive paired wire. They are wired and routed in parallel series to a coin cell battery holder with on/off switch (power supply). Advanced model may have high/low intensity switch attached to power supply.

Once prepared, the paralleled wired vibrating mini motor discs on harness are fed into the sweat headband's hollow channel through a single hole, along the left and right sides. The vibrating mini motor disc (V.M.M.D.) are strategically placed then sewn stationary. The coin cell battery holder with on/off switch is attached side way on the right side rear exterior of the sweat headband.

The Headache Tension Massage Headband is complete.

When the Headache Tension Massage Headband is stretched and placed on head the vibrating mini motor disc (V.M.M.D.) are aligned to apply direct vibration massaging to key positions on the head; the frontal lobe area, temporal lobe area and occipital lobe area.

### SEQUENCE LISTING

Not Applicable

### REFERENCES

Ca., J. B. (2015, 10 22). U.S. Pat. No. 6,179,794. Retrieved from [US Patent & Trademark Office, Patent Full Text and Image Database]: http://patft.uspto.gov/netacgi/nph-Parser?Sect2=PTO1&Sect2=HITOFF&p=1&u=%2Fnetahtml%2FPTO%2Fsearch-bool.html&r=1&f=G&I=50&d=PALL&RefSrch=yes&Query=PN%2F6179794

University, N. H. (2015, 10 19). Google search page, define massage therapy. Retrieved from

Massage Therapy Definition-Massage Therapy School . . . : https://www.google.com/search?source?sourceid=navclient&ie=UTF-8&rlz=1T4WQIA_enUS542US599&q=massage+field+of+endeavor+#q=define+massage+therapy

What is claimed:

1. A stretchable cloth sweat headband used as housing support for a plurality of vibrating mini motor disc, size 0.5 inch to 1 inch diameter 0.25 inch height circular pad, to relieve tension by electromechanical waves vibration massage.

2. A method to apply direct electromechanical waves vibration massaging to key positions on the head's the frontal lobe, temporal lobe and occipital lobe area.

3. A method of electromechanical waves vibration massage to relieve headache tension, promote relaxation and well-being.
